(19) United States
(12) Patent Application Publication
(10) Pub. No.: US 2003/0236652 A1
(43) Pub. Date: Dec. 25, 2003

(54) System and method for anomaly detection

(75) Inventors: Chad Scherrer, Pasco, WA (US); Bradley Woodworth, Richland, WA (US)

Correspondence Address: Michael A. Kerr, Virtual Legal, Ste. 211, 777 William St., Carson City, NV, 89701, US

(73) Assignee: Battelle, Richland, WA

(21) Appl. No.: 10/449,755

(22) Filed: May 29, 2003

Related U.S. Application Data
(60) Provisional application No. 60/384,492, filed on May 31, 2002.

(51) Int. Cl. G06F 17/10

(52) U.S. Cl. 703/2

(57) ABSTRACT

A system and method for detecting one or more anomalies in a plurality of observations. In one illustrative embodiment, the observations are real-time network observations collected from a plurality of network traffic. The method includes selecting a perspective for analysis of the observations. The perspective is configured to distinguish between a local data set and a remote data set. The method applies the perspective to select a plurality of extracted data from the observations. A first mathematical model is generated with the extracted data. The extracted data and the first mathematical model is then used to generate scored data. The scored data is then analyzed to detect anomalies.

### CROSS REFERENCES TO RELATED APPLICATIONS

This patent application is related to provisional patent application No. 60/384,492 that was filed on May 31, 2002 which is hereby incorporated by reference.

### BACKGROUND

1. Field of Invention

The invention is related to analyzing a plurality of data. More particularly, the invention is related to systems and methods that evaluate data.

2. Description of Related Art

Anomaly detection has been applied to computer security, network security, and identifying defects in semiconductors, superconductor conductivity, medical applications, testing computer programs, inspecting manufactured devices, and a variety of other applications. The principles that are typically used in anomaly detection include identifying normal behavior and a threshold selection procedure for identifying anomalous behavior. Usually, the challenge is to develop a model that permits discrimination of the abnormalities.

By way of example and not of limitation, in computer security applications one of the critical problems is distinguishing between normal circumstance and “anomalous” or “abnormal” circumstances. For example, computer viruses can be viewed as abnormal modifications to normal programs. Similarly, network intrusion detection is an attempt to discern anomalous patterns in network traffic. The detection of anomalous activities is a relatively complex learning problem in which the detection of anomalous activities is hampered by not having appropriate data and/or because of the variety of different activities that need to be monitored. Additionally, defenses based on fixed assumptions are vulnerable to activities designed specifically to subvert the fixed assumptions.

To develop a solution for an anomaly detection problem, a strong model of normal behaviors needs to be developed. Anomalies can then detected by identifying behaviors that deviate from the model.

### SUMMARY

A system and method for detecting one or more anomalies in a plurality of observations is described. In one illustrative embodiment, the observations are real-time network observations collected from a plurality of network traffic. The method includes selecting a perspective for analysis of the observations. The perspective is configured to distinguish between a local data set and a remote data set. The method applies the perspective to select a plurality of extracted data from the observations. A first mathematical model is generated with the extracted data. The extracted data and the first mathematical model is then used to generate scored data. The scored data is then analyzed to detect anomalies.

In one embodiment, the perspective is a geographic perspective in which one or more territorial boundaries are used to distinguish between the local data set and the remote data set. In another embodiment, the perspective is an organizational perspective in which organizational boundaries are used to distinguish between the local data set and the remote data set. In yet another embodiment, the perspective is a network perspective in which network boundaries are used to distinguish between the local data set and the remote data set. In still another embodiment, the perspective is a host perspective wherein the local data set is associated with a particular host.

In the illustrative embodiment, the observations are real-time observations that include Internet Protocol (IP) addresses. These observations are used to generate the first mathematical model. In one illustrative embodiment, the first mathematical model is a graphical mathematical model such as a graphical Markov model. The graphical mathematical model includes a plurality of vertices in which each vertex corresponds to a variable within the observations. In the illustrative embodiment, the vertices are configured to represent a plurality of discrete variables.

The scored data is generated with a dictionary having the plurality of extracted data stored thereon. Typically, the dictionary is updated with extracted data collected on a real-time basis. The dictionary is decayed so that older extracted is discarded from the dictionary. The updated and decayed dictionary is used to generate the scored data.

In one illustrative example the scored data is analyzed by identifying at least one threshold for anomaly detection. The scored data is then compared to the threshold to determine if one or more anomalies have been detected.

The system and method also permits the first mathematical model to be validated by generating a second mathematical model using recently extracted data. The first mathematical model which includes historical extracted data is compared to the second mathematical model which includes recently extracted data. The correlation between the first mathematical model and second mathematical model is determined by a correlation estimate that is based on the concordances of randomly sampled pairs.

Additionally, the method may also provide for the clustering of the plurality of scored data. Clustering provides an additional method for analyzed the scored data. Clustering is performed when the scored data is similar to an existing cluster. Additionally, clustering of the scored data includes using a threshold to cluster the scored data.

### BRIEF DESCRIPTION OF THE DRAWINGS

Embodiments for the following description are shown in the following drawings:

FIG. 1 is an illustrative general purpose computer.

FIG. 2 is an illustrative client-server system.

FIG. 3 is a data flow diagram from detecting anomalous activities.

FIG. 4 is a flowchart of a method for anomaly detection.

FIG. 5 is a drawing of a global perspective.

FIG. 6 is a drawing of a territorial perspective.

FIG. 7A is a drawing of an organizational perspective.

FIG. 7B is an illustrative drawing showing the organizational perspective in which the organization is the Department of Energy.

FIG. 8A is a drawing showing a site perspective.

FIG. 8B is an illustrative example of the site perspective in which the site is the Pacific Northwest National Laboratory.

FIG. 9 is a drawing showing a network perspective in which the network defines the boundary condition.

FIG. 10 is a drawing of a host perspective.

FIG. 11A is an illustrative perspective tree for an illustrative data record.

FIG. 11B is a perspective diagram for the perspective tree of FIG. 11A.

FIG. 12A and FIG. 12B is a flowchart for an illustrative method of automated model generation.

FIG. 13 is a flowchart for an illustrative method of scoring data with the mathematical model.

FIG. 14 is a flowchart for a method of validating a mathematical model.

FIG. 15 is a flowchart for a method of performing a clustering analysis.

FIG. 16 is an illustrative screenshot showing a visual graph.

### DESCRIPTION

In the following detailed description, reference is made to the accompanying drawings, which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the claims. The following detailed description is, therefore, not to be taken in a limited sense.

Note, the leading digit(s) of the reference numbers in the Figures correspond to the figure number, with the exception that identical components which appear in multiple figures are identified by the same reference numbers.

The illustrative anomaly detection systems and methods have been developed to assist the security analyst in identifying, reviewing and assessing anomalous network traffic behavior. It shall be appreciated by those skilled in the art having the benefit of this disclosure that these illustrative systems and methods can be applied to a variety of other applications that are related to anomaly detection. For the illustrative embodiment of cyber security and/or network intrusion, an anomalous activity is an intrusion that results in the collection of information about the hosts, the network infrastructure, the systems and methods for network protection, and other sensitive information resident on the network.

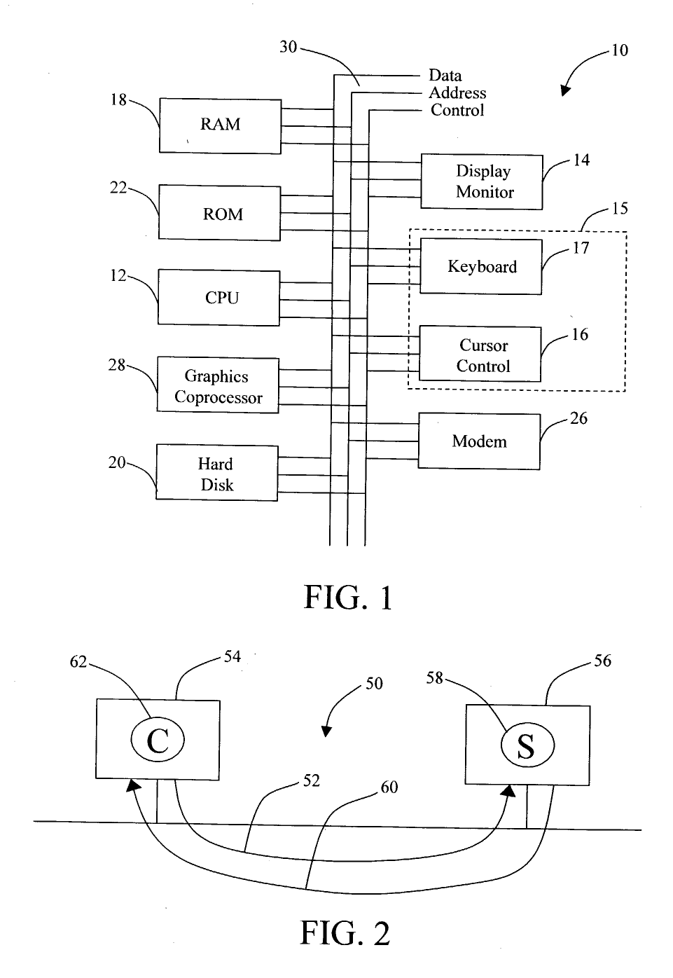

Referring to FIG. 1 there is shown an illustrative general purpose computer 10 suitable for implementing the systems and methods described herein. The general purpose computer 10 includes at least one central processing unit (CPU) 12, a display such as monitor 14, and an input device 15 such as cursor control device 16 or keyboard 17. The cursor control device 16 can be implemented as a mouse, a joy stick, a series of buttons, or any other input device which allows user to control the position of a cursor or pointer on the display monitor 14. Another illustrative input device is the keyboard 17. The general purpose computer may also include random access memory (RAM) 18, hard drive storage 20, read-only memory (ROM) 22, a modem 26 and a graphic co-processor 28. All of the elements of the general purpose computer 10 may be tied together by a common bus 30 for transporting data between the various elements.

The bus 30 typically includes data, address, and control signals. Although the general purpose computer 10 illustrated in FIG. 1 includes a single data bus 30 which ties together all of the elements of the general purpose computer 10, there is no requirement that there be a single communication bus which connects the various elements of the general purpose computer 10. For example, the CPU 12, RAM 18, ROM 22, and graphics co-processor might be tied together with a data bus while the hard disk 20, modem 26, keyboard 24, display monitor 14, and cursor control device are connected together with a second data bus (not shown). In this case, the first data bus 30 and the second data bus could be linked by a bi-directional bus interface (not shown). Alternatively, some of the elements, such as the CPU 12 and the graphics co-processor 28 could be connected to both the first data bus 30 and the second data bus and communication between the first and second data bus would occur through the CPU 12 and the graphics co-processor 28. The methods of the present invention are thus executable on any general purpose computing architecture, but there is no limitation that this architecture is the only one which can execute the methods of the present invention.

The system for detecting anomalies one or more anomalies may be embodied in the general purpose computer 10. A first memory such as RAM 18, ROM 22, hard disk 20, or any other such memory device can be configured to store data for the methods descried. An observation is a multivariate quantity having a plurality of components wherein each component has a value that is associated with each variable of the observation. For the illustrative embodiment the observations are real-time network observations collected from a plurality of network traffic that include Internet Protocol (IP) addresses and/or port numbers. It shall be appreciated by those of ordinary skill in the art that an observation may also be referred to as a data record.

The input device 15 receives an instruction from the analyst about the perspective to use for analysis of the plurality of observations. The perspective provides the ability to distinguish between a local data set and a remote data set. The different types of perspectives are described in further detail below. Alternatively, a default perspective may be provided.

The processor 12 is programmed to apply the perspective to select a plurality of extracted data from the observations, and to generate a first mathematical model with the plurality of extracted data. Additionally, the processor 12 generates a plurality of scored data by applying the extracted data to the first mathematical model, and analyzes the scored data to detect one or more anomalies.

In the illustrative embodiment the each of the mathematical models that the processor 20 is programmed to generate are graphical mathematical models such as a graphical Markov model. The illustrative graphical Markov model is composed of an independent graph where each vertex corresponds to a variable or component within the plurality of observations. In the illustrative graphical Markov model, the plurality of vertices are configured to represent a plurality of discrete variables, and there are at least two variables having an associated edge.

A second memory residing within said RAM 18, ROM 22, hard disk 20, or any other such memory device is configured to store a plurality of extracted data. Recall extracted data is the data extracted after performing a perspective analysis. The second memory is configured to store a dictionary that is updated with extracted data collected on a real-time basis by processor 12. Additionally, the dictionary is decayed by processor 12 so that a plurality of older data, i.e. historical data, is discarded from the dictionary. The processor 12 then takes the updated and decayed dictionary and generates the scored data using the first mathematical model.

Once the scored data is generated, the processor 12 is programmed to analyze the scored data. In one illustrative example, the scored data is analyzed by identifying at least one threshold for anomaly detection. The threshold value may be identified by an analyst or may be a pre-programmed default value. The processor 12 is the programmed to compare the threshold to the scored data to determine if one or more anomalies have been detected.

The processor 12 is also programmed to validate the first mathematical model by generating a second mathematical model using recently extracted data. The processor 12 is programmed to compare the first mathematical model having more historical data records with the second mathematical model having more recent data records. The processor 12 is programmed to find a correlation between the first mathematical model and the second mathematical model with a correlation estimate that is based on the concordances of randomly sampled pairs. The method for comparing the first mathematical model to the second mathematical model is described in further detail belowl.

Additionally, the system embodied in the general purpose computer 10 may also provide for programming the processor 12 to cluster the plurality of scored data. Clustering provides an additional method for analyzing the scored data. The processor may be programmed to cluster the scored data that is similar to an existing cluster, and to cluster scored data above a threshold.

Alternatively, the methods of the invention can be implemented in a client/server architecture which is shown in FIG. 2. It shall be appreciated by those of ordinary skill in the art that a client/server architecture 50 can be configured to perform similar functions as those performed by the general purpose computer 10. In the client-server architecture communication generally takes the form of a request message 52 from a client 54 to the server 56 asking for the server 56 to perform a server process 58. The server 56 performs the server process 58 and sends back a reply 60 to a client process 62 resident within client 54. Additional benefits from use of a client/server architecture include the ability to store and share gathered information and to collectively analyze gathered information. In another alternative embodiment, a peer-to-peer network (not shown) can used to implement the methods of the invention.

In operation, the general purpose computer 10, client/server network system 50, and peer-to-peer network system execute a sequence of machine-readable instructions. These machine readable instructions may reside in various types of signal bearing media. In this respect, one aspect of the present invention concerns a programmed product, comprising signal-bearing media tangibly embodying a program of machine-readable instructions executable by a digital data processor such as the CPU 12 for the general purpose computer 10.

It shall be appreciated by those of ordinary skill that the computer readable medium may comprise, for example, RAM 18 contained within the general purpose computer 10 or within a server 56. Alternatively the computer readable medium may be contained in another signal-bearing media, such as a magnetic data storage diskette that is directly accessible by the general purpose computer 10 or the server 56. Whether contained in the general purpose computer or in the server, the machine readable instruction within the computer readable medium may be stored in a variety of machine readable data storage media, such as a conventional “hard drive” or a RAID array, magnetic tape, electronic read-only memory (ROM), an optical storage device such as CD-ROM, DVD, or other suitable signal bearing media including transmission media such as digital and analog and communication links. In an illustrative embodiment, the machine-readable instructions may comprise software object code from a programming language such as C++, Java, or Python.

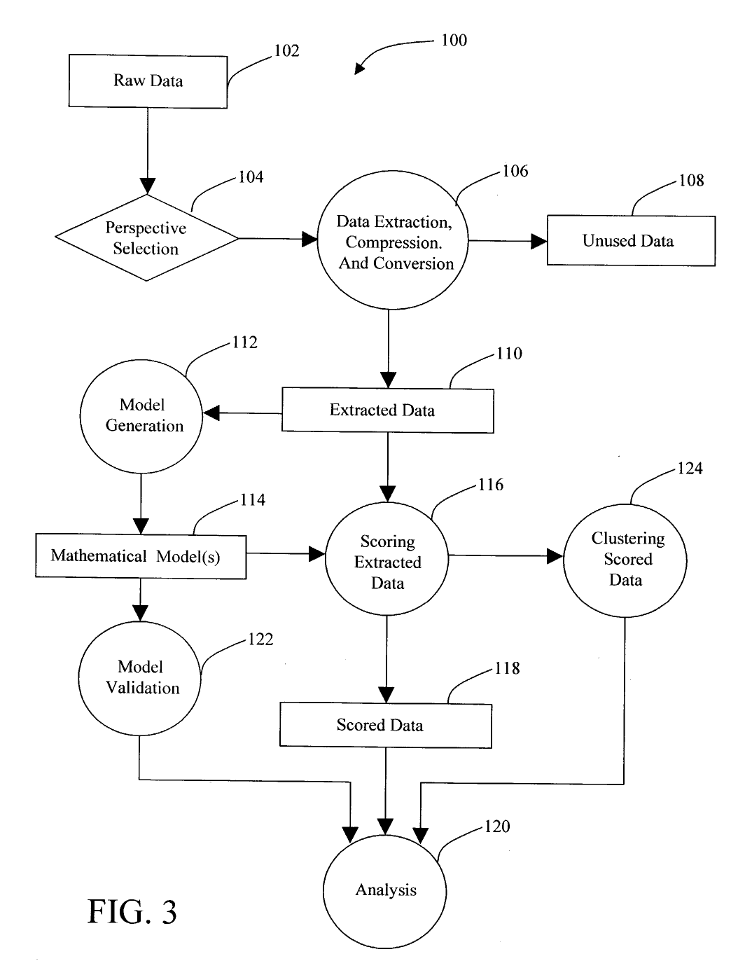

FIG. 3 is a data flow diagram that describes the data flow for detecting anomalous activities within a plurality of data records or observations. The method 100 is initiated with the receiving of a plurality of raw data records identified by block 102. The raw data records represents a plurality of observations that are stored in a memory such as RAM 18, ROM 22, or hard disk 20 of FIG. 1.

For illustrative purposes only, the raw data are observations of nominal data. An observation is a multivariate quantity having a plurality of components wherein each component has a value that is associated with each variable of the observation. Nominal data is a kind of categorical data where the order of the categories is arbitrary. Nominal data may be counted, but not ordered or measured. By way of example and not of limitation, nominal data includes: type of food, type of computer, occupation, brand name, person's name, type of vehicle, country, internet protocol (IP) address and computer port number.

For the illustrative network security application, the raw data includes IP addresses and port numbers which have numeric values associated with them. The nominal data values associated with IP addresses and ports only serve as labels. For the illustrative example of monitoring network intrusion in the network security application, typical logs and data sets used for intrusion detection apply date, time, source address, destination addresses and ports to describe the communications occurring on each port. Thus, the raw data for the illustrative embodiment is related to real-time network observations collected from a plurality of network traffic.

After the raw data is received in block 102, a perspective 104 is selected. Generally, a perspective differentiates between a set of “local” data records and a set of “remote” data records. Additionally, for each data record the determination is made whether the data record is generated from a particular source or is associated with a particular destination. Thus, the illustrative perspective analysis provides four directions for the flow of data records. As shown in Table 1, the four directions for the flow of data records are received, sent, internal, and external.

TABLE 1
DIRECTIONS

| Direction | Source | Destination |
|---|---|---|
| Received | Remote | Local |
| Sent | Local | Remote |
| Internal | Local | local |
| External | Remote | remote |

Therefore, if a source is remote and the destination is local, then the direction for the flow of the data record is “received”. If the source is local and the destination is remote, then the direction of data flow is “sent”. When the source is local and the destination is local, then the direction is identified as “internal”. When the source and the destination are both remote, then the direction of the data flow is “external”.

Out of these four possible directions for data flow, the illustrative system and method for anomalous detection only extracts data records that are “sent” and “received”. The sent and received data records are referred to as the “scope” of the current perspective. Thus, the scope determines which data records are extracted from the initial pool of raw data.

During the perspective selection process it may be necessary to perform a perspective transformation to bring a different set of data records into scope. An illustrative example of three perspective transformations for analyzing IP addresses include the subset transformation, the superset transformation, and the disjoint set transformation. Referring to Table 2, there is shown the resulting scope associated with performing the perspective transformations.

TABLE 2
PERSPECTIVE TRANSFORMATIONS

| Transformation | Sent | Received | Internal | External |
|---|---|---|---|---|
| Subset | sent, | received, | sent, received, | external |
| | external | external | internal, | |
| | | | external | |
| Superset | sent, | received, | internal | sent, received, |
| | internal | internal | | internal, |
| | | | | external |
| Disjoint Set | received, | sent, | external | sent, received, |
| | external | external | | internal, |
| | | | | external |

The subset transformation is a transformation in which there is a removal of some addresses from the current perspective. The superset transformation is a transformation in which some addresses are added to the current perspective. The disjoint set transformation is a transformation in which there is a switch to a completely different set of addresses, having no common elements with the current perspective. By way of example and not of limitation, the Pacific Northwest national Laboratory (PNL) is disjoint from Sandia National Laboratory (SNL). A packet which has been sent by PNL may have been received by SNL, or it may be external to SNL.

The process of extracting data is performed at process 106. Typically, the data extraction process 106 results in a compression of the raw data received from process block 102. Additionally, the extraction process may also include the conversion of data to a format that facilitates downstream processing. The remaining plurality of unused data 108 can be processed in a variety of different ways including storage, selective storage, and/or deletion.

The extracted data 110 which is produced from the data extraction process 106 is then used to generate a first mathematical model in the model generation process 112. In the illustrative embodiment, the first mathematical model generated during the model generation process 112 is a graphical mathematical model such as a graphical Markov model. The graphical mathematical model includes a plurality of vertices in which each vertex corresponds to a variable associated with real-time network observations. In the illustrative embodiment, the vertices are configured to represent a plurality of discrete variables.

The resulting mathematical model 114 is then communicated to process 116 where the extracted data is scored. Alternatively, raw data may be scored. However for purposes of the illustrative embodiment extracted data is scored by applying the extracted data 110 to the mathematical model 114 to generate scored data in process 116. Alternatively, raw data 102 is applied to the mathematical model 114 to generate the scored data 116. In the illustrative embodiment, the scored data is generated with a dictionary having the plurality of extracted data stored thereon. Typically, the dictionary is updated with extracted data collected on a real-time basis. The dictionary is decayed so that older extracted data is discarded from the dictionary. The updated and decayed dictionary is used to generate the scored data. The updating and decaying of the dictionary is described in further detail below.

During the process of scoring 116, each scored data record is assigned a real number value to indicate its relative surprise within the context of all data processed by each of the mathematical models in block 114. Once the results from the scoring have been sorted, the scored data results 118 are communicated to the analyst. During the analysis 120, the analyst inspects scored data with the highest surprise value. In one illustrative example the scored data is analyzed by identifying at least one threshold. The scored data 118 is then compared to the threshold to determine if one or more anomalies have been detected.

Additionally, it is preferable to perform the processes of model validation 122 and clustering 124. However, the process of model validation is not required to perform anomaly detection. Nevertheless, the process of model validation helps ensure that the model is strong and permits the model to be revised on a real-time basis. During the process of model validation 122, the first mathematical model is compared to a second mathematical model. Typically, the second mathematical model is generated using recently extracted data. Thus, the first mathematical model includes more historical data than the second mathematical model. In the illustrative example, the correlation between the first mathematical model and second mathematical model is determined by a correlation estimate that is based on the concordances of randomly sampled pairs. The results of this comparison are then communicated to the analyst for further analysis. The method used to compare the first mathematical model to the second mathematical model is described in further detail below.

Additionally, there are benefits associated with clustering the scored data as shown in process 124 that include providing an additional analytical tool, and the ability to generate a two-dimensional view or three-dimensional view of the detected anomalies. By way of example and not of limitation, clustering is performed when the scored data is similar to an existing cluster. Additionally, clustering of the scored data can also be performed by using a clustering threshold to cluster the scored data.

The purpose of clustering process 124 is to give an analyst “context” by which and analysis can be conducted. A single high scoring result gives little help to analysts unless the reason for the high score is known. Additionally, it would be preferable to identify other data records, extracted data records, or scored data that may relate to the single high scoring result. This permits the analyst to dive deeper into the examination during the analysis 120. It is envisioned that there may be several clusters generated from a single high surprise value seed. By way of example and not of limitation, these clusters may group records based on minimal distance from the seed by looking at geographic, or organizational, time or activity measures.

By combining a comparative analysis of a variety of mathematical models, with the scoring results for each model, and the clustering of the scored data, the method 100 provides a simple and robust procedure for detecting anomalous network behavior. It shall be appreciated by those of ordinary skill in the art having the benefit of this disclosure that these methods may also be adapted for use in other applications related to detecting anomalous in a plurality of data records.

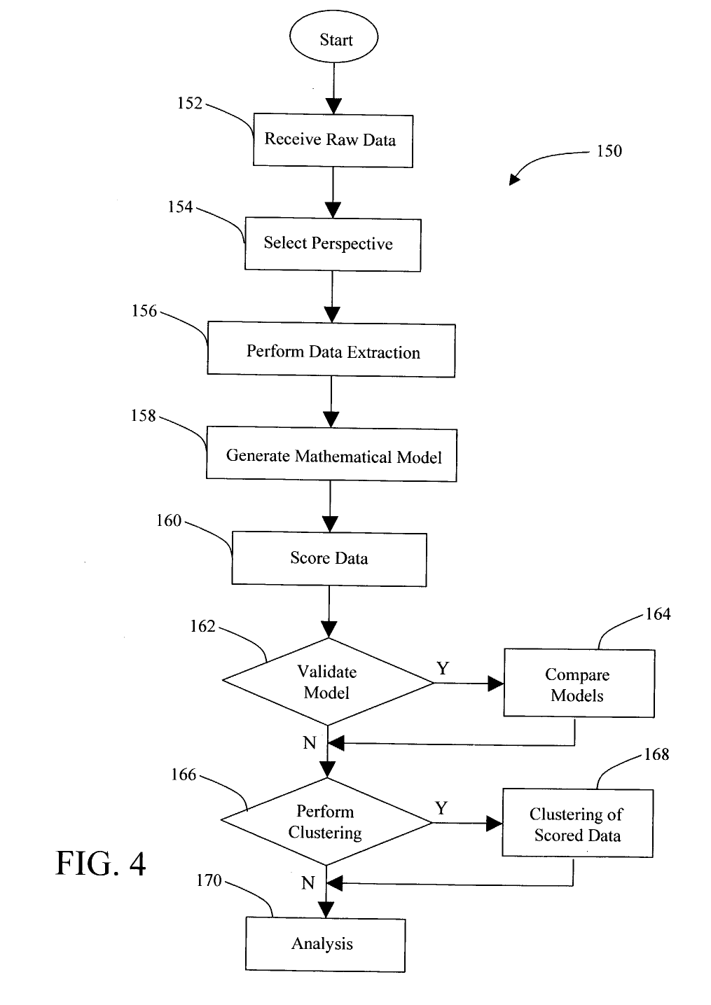

FIG. 4 is a flowchart of the method 150 for anomaly detection. In this flowchart, the various blocks describe the various processes that are associated with the transfer of control from one process block to another process block. The processes described in FIG. 4 are substantially similar to the processes described in FIG. 3.

The method 150 is initiated in process block 152 where the raw data is collected. As described above, the raw data is composed of a plurality of observations of nominal data that are associated with ordered and discrete variables, i.e. categorical variables. For the illustrative network security application, the raw data is related to real-time network observations collected from a plurality of network traffic.

After the raw data is received in process block 152, a perspective is selected in process block 154. Generally, a perspective differentiates between a set of “local” data records and a set of “remote” data records. In one embodiment, the perspective is a geographic perspective in which one or more territorial boundaries are used to distinguish between the local data set and the remote data set. In another embodiment, the perspective is an organizational perspective in which organizational boundaries are used to distinguish between the local data set and the remote data set. In yet another embodiment, the perspective is a network perspective in which network boundaries are used to distinguish between the local data set and the remote data set. In still another embodiment, the perspective is a host perspective wherein the local data set is associated with a particular host. Each of these perspectives are described in further detail below.

The method applies the perspective from process block 154 to select a plurality of extracted data from the observations in the raw data. The process of generating the plurality of extracted data by performing the data extraction process is shown in process block 156. In the illustrative embodiment, the extracted data includes data generated from real-time network observations such as IP addresses and port numbers. More particularly, the illustrative embodiment differentiates between internal, external, sent and received data records. The illustrative embodiment then proceeds to extract the sent data records and the received data records and discards the internal and external data records. As described above, the perspective determines how to categorize the raw data records.

Preferably, the method generates a mathematical model with the extracted data in process block 158. Alternatively, the method can bypass the perspective selection process 154 and the data extraction process 156 and use the raw data to generate the mathematical model in process block 158. In the illustrative embodiment, the first mathematical model is a graphical mathematical model such as a graphical Markov model. The graphical mathematical model includes a plurality of vertices in which each vertex corresponds to a variable within the network observations. In the illustrative embodiment, the vertices are configured to represent a plurality of discrete variables.

The method then generates a plurality of scored data records by scoring the data in process block 160. In the preferred embodiment, extracted data from process 156 is applied to the mathematical model from block 158 to generate scored data in process block 160. Alternatively, raw data from block 152 is applied to the mathematical model from block 158 to generate the scored data in process block 160. In the illustrative embodiment, the scored data is generated with a dictionary having the plurality of extracted data stored thereon. Typically, the dictionary is updated with extracted data collected on a real-time basis. The dictionary is decayed so that older extracted is discarded from the dictionary. The updated and decayed dictionary is used to generate the scored data.

Once the scored data is generated, the scored data is analyzed in process block 170 to detect anomalies. In one illustrative example the scored data is analyzed by identifying at least one threshold for anomaly detection. The scored data is then compared to the threshold to determine if one or more anomalies have been detected.

Although, analysis of the scored data can be performed immediately after generating the scored data, it is preferable to perform the additional processes of model validation and clustering the scored data. To reflect that process of model validation is not required to perform the process of anomaly detection, the process of determining whether to perform model validation is described in decision diamond 162. If the decision is made to validate the mathematical model generated in block 158, then the method proceeds to process block 164 where the first mathematical model generated in block 158 is correlated is compared to a second mathematical model. The first mathematical model is validated by generating a second mathematical model using recently extracted data or recently collected raw data. The first mathematical model includes more historical data than the second mathematical model. In the illustrative example, the correlation between the first mathematical model and second mathematical model is determined by a correlation estimate that is based on the concordances of randomly sampled pairs. The method used to compare the first mathematical model to the second mathematical model is described below.

Additionally, it may be desirable to cluster the scored data. There are a variety of benefits associated with clustering scored data that include providing an additional analytical tool, and the ability to generate a two-dimensional view or three-dimensional view of the detected anomalies. Thus, the method provides for determining whether to perform the step of clustering the scored data at decision diamond 166. If the decision is made to cluster the scored data, the method proceeds to process block 168 where clustering of the scored data is performed. By way of example and not of limitation, clustering is performed when the scored data is similar to an existing cluster. Additionally, clustering of the scored data can also be performed by using a clustering threshold to cluster the scored data.

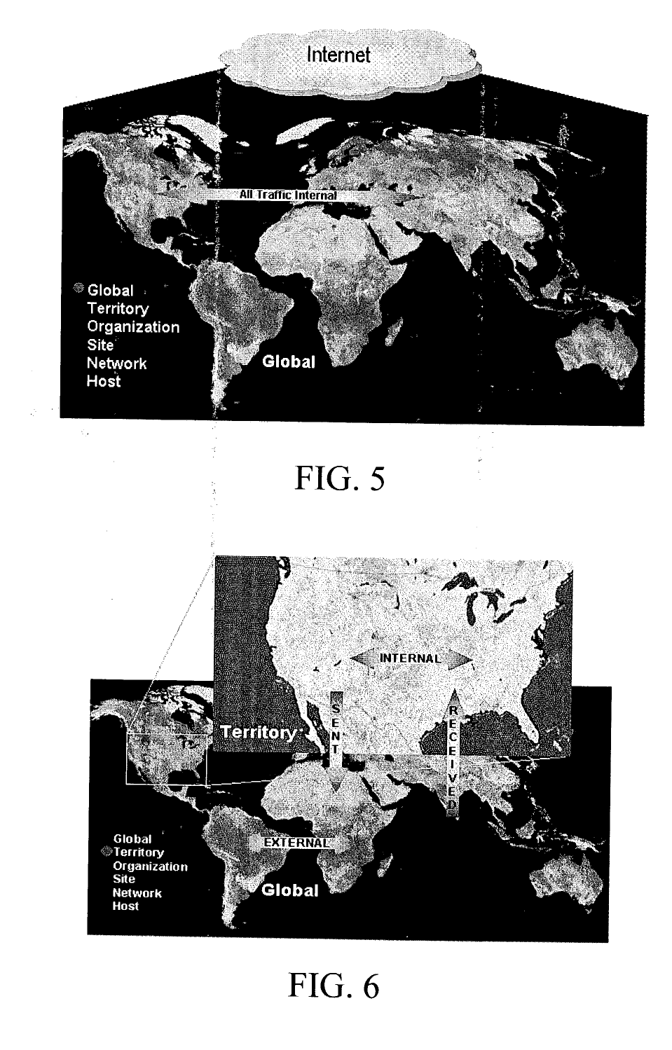

Referring to FIG. 5 through FIG. 10 there is shown a variety of different perspectives that may be selected during the perspective selection process 104 and process 154 described in FIG. 3 and FIG. 4, respectively. In one embodiment, the perspective is a geographic perspective in which one or more territorial boundaries are used to distinguish between the local data set and the remote data set. In another embodiment, the perspective is an organizational perspective in which organizational boundaries are used to distinguish between the local data set and the remote data set. In yet another embodiment, the perspective is a network perspective in which network boundaries are used to distinguish between the local data set and the remote data set. In still another embodiment, the perspective is a host perspective wherein the local data set is associated with a particular host.

Referring to FIG. 5 there is shown a drawing of a global perspective in which the Internet is viewed as being within the global perspective, and all IP addresses are “internal” to this global perspective. The source for each IP address and the destination for each IP address are within a local data set and there is little or no remote data set in the global perspective.

Referring to FIG. 6 there is shown a drawing of a territorial perspective. For the territorial perspective the boundaries of the territory define the local data set and remote data set. The illustrative territory is the United States of America. Therefore, any data records that crosses the territorial boundary are labeled sent or received depending on the direction traveled between the source and the destination. All data records that remain within the boundary are labeled internal, and all the data records that remain outside the border are labeled external.

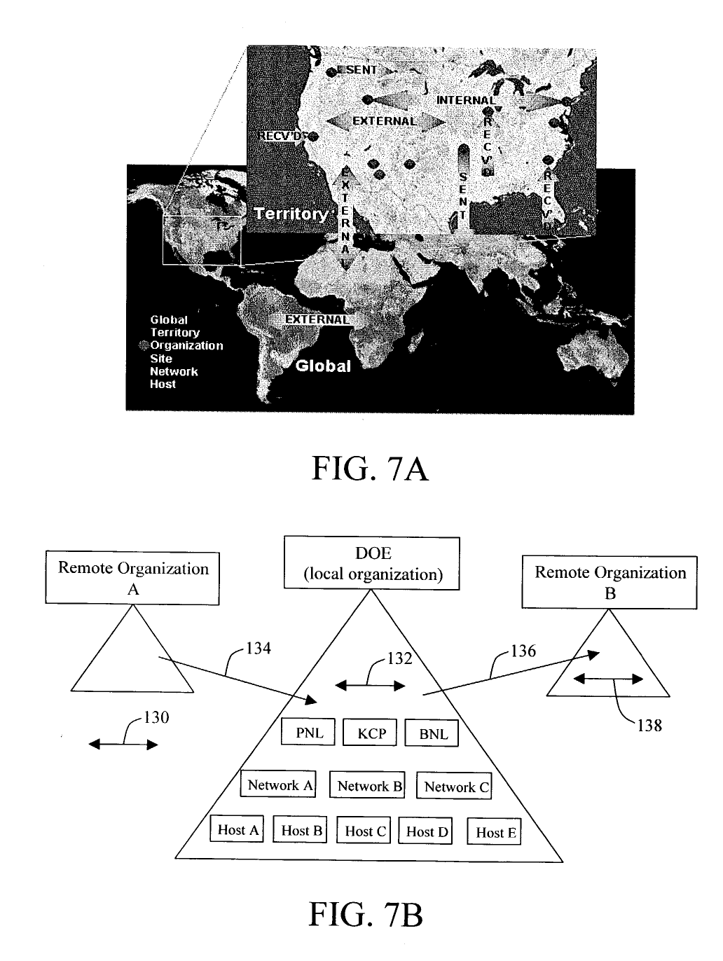

Referring to FIG. 7A there is shown a drawing of an organizational perspective. The organizational perspective is a perspective that distinguish between a local data set and a remote data set based on an organizational structure. By way of example and not of limitation, an organizational structure includes individuals, partnerships, corporations, joint ventures and any other such grouping for a common purpose. For the illustrative network security embodiment, the organizational structure is not rigidly definable, but can be loosely defined as a collection of sites or physical locations. These physical locations do not have to be restricted to a specific territory, and can be scattered throughout the Internet.

An illustrative example of an organizational perspective for the Department of Energy (DOE) is provided in FIG. 7B. The DOE is viewed as providing the local data set and being the “local organization”. For the illustrative example, the direction of data flow is divided into external 130, internal 132, received 134, sent 136, and external 138. The DOE organization is an “umbrella” organization associated with a plurality of smaller organizations or sites such as the Pacific Northwest National Laboratory (PNL), the Kansas City Plan (KCP), and the Brookhaven National Laboratory (BNL) that are scattered throughout the United States. For purposes of this patent application the term “site” refers to an organization that is principally confined to a particular location, e.g. PNL is located in Richland, Wash.

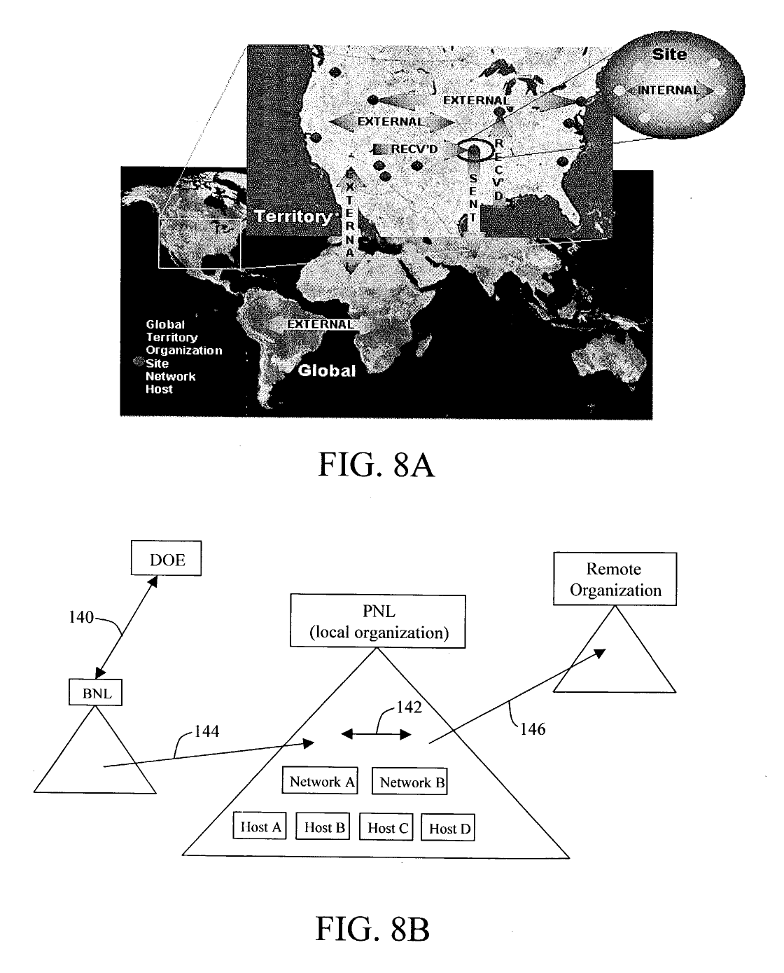

Referring to FIG. 8A there is shown an illustrative perspective for a site perspective. In a site perspective, the physical location of the site defines the local data set. For the illustrative embodiment, the site perspective provides IP addresses that settle into organized groups in which any network traffic that crosses the site boundary is labeled “sent” or “received” depending on the location of the source of the IP address and destination for the IP address. Meanwhile those packets that remain within the site boundary are labeled internal and those packets that remain outside the site boundary are labeled “external”.

An illustrative example of the site perspective is provided in FIG. 8B where the local data set is identified by the PNL site. The PNL site is also referred to as the local organization. Thus, anything outside the PNL site is remote and belongs in the remote data set. For the illustrative example, the data flow is external if outside the PNL site. The “external” data flow is referenced in arrow 140 which represents communications between the DOE and the BNL. The data flow is “internal” when the data flow is between computers residing within the PNL site as shown by arrow 142. The “received” data represented by arrow 144 crosses the site boundary and is generated by a source that is remote to the PNL site. The “sent” data is represented by arrow 146 and shows data being transferred from the PNL site to an illustrative remote organization.

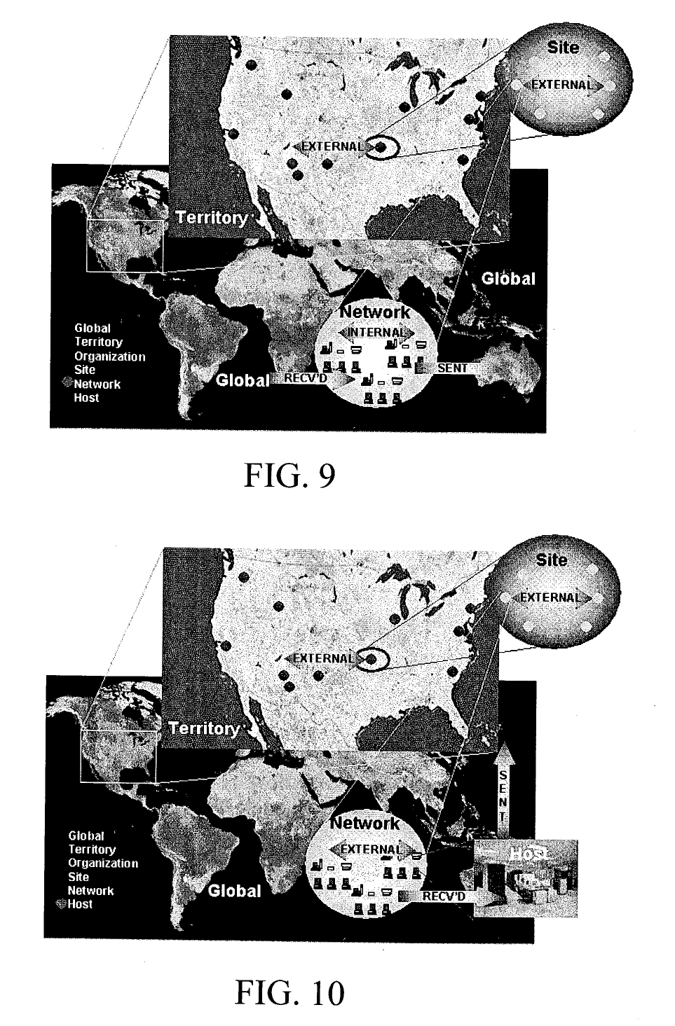

Referring to FIG. 9 there is shown a drawing of a network perspective in which the network defines the local data set and anything outside the network is the remote data set. A network is a collection of hosts tied together with communication devices. A host is a computer connected to a network. Therefore, the data flow from a local network host to another local network host is considered to be “internal”, and the data flow from a remote network to the local network is a received data record. The network perspective can be applied to a site having a plurality of networks. If the site has only one perspective then the network perspective can not be distinguished from the site perspective.

Another illustrative example of a perspective includes a single host perspective shown in FIG. 10. For the host perspective, a single host is used to draw the distinction between a local data set and a remote data set. By way of example and not of limitation, the host could be a mail server or a web server. Communications that occur outside the host are “external” to the host perspective. Communications with the host are labeled as “sent” or “received”.

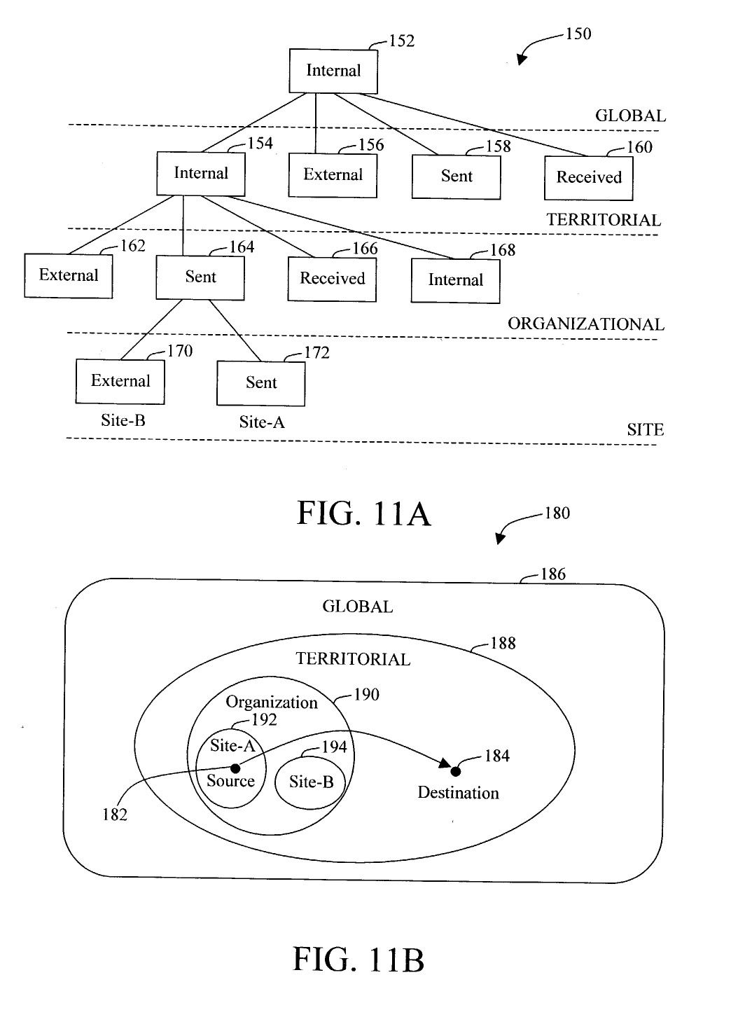

Referring to FIG. 11A there is shown an illustrative perspective tree for an illustrative data record. The illustrative data record has a source within a first state and a destination within a second state wherein the first state and the second date are within the United States. The illustrative perspective tree includes a plurality of levels that includes the global perspective, a territorial perspective, an organizational perspective and a site perspective. At the global perspective, the illustrative data record is labeled as internal 152 because the illustrative data record is within the set of local data records, i.e. world.

When the illustrative data record is viewed from the territorial perspective of a particular jurisdiction such as the United States, the illustrative data record is again labeled as internal 154 because the source and destination of the illustrative data packet are both within the territorial boundaries of the United States. However, at the territorial perspectives defined by the United States there are other data records that may be external 156, sent 158 and received 160.

At the organizational perspective, the illustrative data record is labeled as sent 164. Thus, the illustrative data packet is sent from the local organization to a remote destination. At the organizational perspective, the internal data records from the territorial perspective can be viewed as being external 162, sent 164, received 166 and internal 168.

At the site perspective, the illustrative data record that was labeled as a sent data record from the organizational perspective, is labeled as either being external 170 or as being sent 172. The determination of whether to label the illustrative data record as external 170 or as being sent 172 is dependent on the differentiating between local data records and remote data records.

Referring to FIG. 11B there is shown a perspective diagram. The perspective diagram 180 provides another visual representation of the illustrative data record that was described in FIG. 11A. For the perspective diagram 180, the illustrative data record is communicated from a source 182 to a destination 184. The global perspective is defined by the global boundaries 186. The territorial perspective is defined by the territorial boundaries 188. For the illustrative data record the territorial boundary is the United States, and the illustrative data record is internal to the territorial perspective. However, at the organizational perspective the illustrative data record is labeled as sent because it crosses the organizational boundary 190. At the site perspective, the illustrative data record is labeled as “sent” if the source is within the Site-A boundary 192. On the other hand, the illustrative data record is labeled as “external” if the source is outside the Site-B boundary 194.

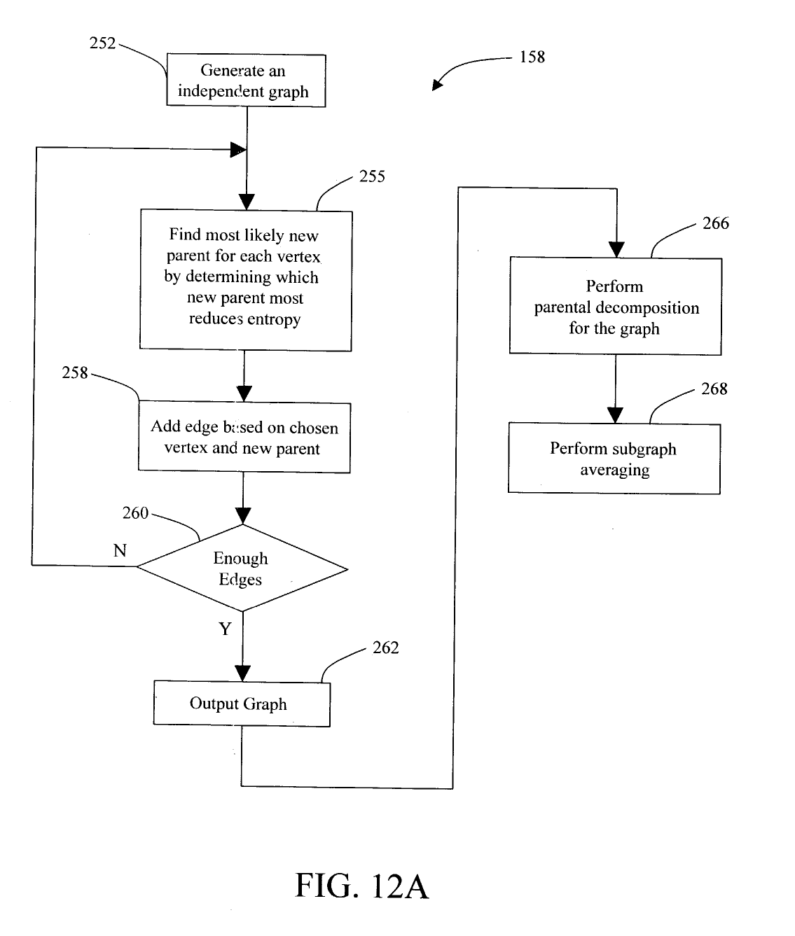

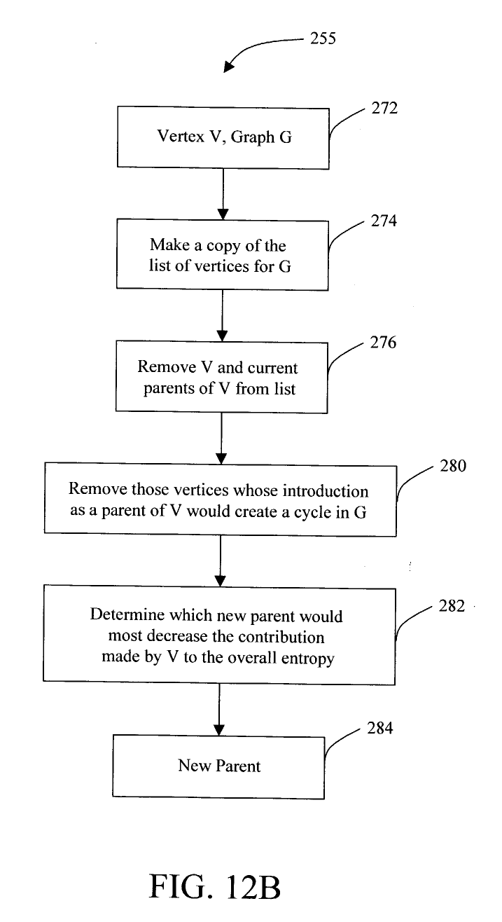

Referring to FIG. 12A and FIG. 12B there is shown a flowchart for an illustrative method of automated model generation. The illustrative method of automated model generation 158, described in FIG. 4, generates a mathematical model using the extracted data collected after performing the perspective selection. In the illustrative method of automated model generation, the mathematical is a graphical mathematical model such as a graphical Markov model.

A graphical Markov model is a class of statistical models in which a graph is used to represent conditional independence relationships among the variables of a probability distribution. Conditional independence is applied in the analysis of interactions among multiple factors. It shall be appreciated by those skilled in the art of statistics that conditional independence is based on the concept of random variables and joint probability distributions over a set of random variables. Intuitively, the concept of conditional independence provides that a dependent relationship between two variables may vanish when a third variable is considered in relation with the former two.

A graph for a graphical Markov model is comprised of a set of vertices, V, and a set of edges, E. The set of vertices, V, acts as an index set for collection of random variables that form a multivariate distribution of some family of probability distributions. For this illustrative embodiment, the set of edges is a set of ordered pairs V×V that does not contain loops.

Additionally, for the illustrative graphical Markov model each of the edges are directed. A directed edge is represented graphically by an arrow pointing from a towards b, i.e. a→b. A graph G=(V, E) is said to be directed if all edges are directed. For a directed edge a→b, a is the parent of b and b is the child of a. Additional information about graphical models and graphical Markov models can be found in “Graphical Models” by S. L. Lauritzen which was published by Oxford University Press in 1996. Another reference is “The Discrete Acyclic Digraph Markov Model in Data Mining” by Juan Roberto Castelo Valdueza.

Referring to process block 252, the method of automated model generation begins with the generation of an independent graph. It shall be appreciated by those of ordinary skill in the art that an independent graph is a graph with no edges in which each vertex represents a variable under consideration. For the illustrative network security application, discrete variables are used for model generation. By way of example and not of limitation, the discrete variables include local IP addresses, remote IP addresses, and port numbers. It shall be appreciated by those of ordinary skill in the art having the benefit of this disclosure that the methods applied to the illustrative discrete variables may also be applied to continuous variables.

After generating the independent graph, the method proceeds to find the most likely new parent for each vertex as described in process block 255. The determination of the most likely new parent for each vertex is based on which new parent most reduces entropy in the graphical mathematical model. The term “entropy” can be applied to random variables, vectors, processes and dynamical systems, and other such information theory and communication theory principles. Intuitively, the concept of entropy is used to account for randomness in the data so that when the entropy is high, i.e. randomness is high, the relationship between the parent and vertex is weak. For further reading on the entropy, please refer to “Elements of Information Theory” by Thomas M. Cover and Joy A. Thomas, published by John Wiley, 1991. A more detailed discussion of the process for finding the most likely new parent for each vertex is described in further detail below in the FIG. 12B discussion.

At block 258, an edge is added to the chosen parent and vertex pair. For the graphical Markov model, the edge is a directed edge. At decision diamond 260, the determination is then made whether there are enough edges. The determination of whether there are sufficient edges is based on a threshold entropy value. Each time an edge is added to the independent graph, the entropy for the graphical Markov model is reduced. For illustrative purposes only, if the entropy is less than 10⁻⁸, then sufficient edges have been generated for the graphical Markov model. If there are not enough edges, the method returns to block 254 and repeats the processes described in block 256 and 258.

The output graph that is generated in 262 is typically a graph having a plurality of vertices and a plurality of edges. The resulting output graph described in block 262 is not a saturated graph. A saturated graph is a graph in which the introduction of any edge will introduce a cycle.

After the output graph is generated, the illustrative method of model generation performs a parental decomposition for the graph described in block 266. This parental decomposition provides a method of viewing the similarities between two or more output graphs. By recognizing the commonality between two or more output graphs, considerable savings in storage a CPU requirements can be achieved during the subgraph averaging process performed in blocks 268. By way of example and not of limitation, suppose G is the graph:

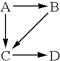

Parental decomposition provides that the information that is stored consists of A, B|A, C|AB, and D|C. Thus each vertex is stored and its respective parent. For a second graph, G′:

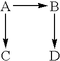

The second graph G′ could be viewed as an entirely new graph. Parental decomposition of G and G′ indicates that the edges for only two vertices have changed. The two vertex and parent combinations that remain unchanged are A, B|A. There are two other vertex and parent combinations that have changed where C|AB has been replaced by C|A, and D|C has been replaced by D|B.

After the parental decomposition of the graph has been completed, the method proceeds to block 268 where subgraph averaging is performed. Subgraph averaging permits the averaging of several mathematical models. Thus, rather than being restricted to a probability model determined by a single graph, an average of several graphical mathematical models is generated.

By way of example and not of limitation, for a model M, let P_{M}[x] be the probability of observation x under model M. Consider the averaged model:

$${P}_{M} [ x ] = {\sum }_{m} {w}_{m} {P}_{{G}_{m}} [ x ]$$

where each wₘ, is a weight for a graph and Σwₘ=1. A variety of different learning methods can be used to weight each subgraph. By way of example and not of limitation, Bayesian methods can be used to determine the weight for each subgraph.

The graphs that are “averaged” can be a collection of subgraphs. For the illustrative graph G from above:

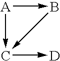

G has 4 edges, so there are 2⁴=16 possible subgraphs. Applying parental decomposition from block 266, the number of possible subgraphs is reduced so that the only storage requirements are for A, B|A, C|AB, and D|C. The weighting for each subgraph of G is described by:

w_{A}=1

w_{B}+w_{B|A}=1

w_{C}+w_{C|A}+w_{C|B}+w_{C|AB}=1

w_{D}+w_{D|C}=1

Thus the number of weights is reduced from 16 to 9, and the number of degrees of freedom has been reduced from 15 to 0+1+3+1=5.

Referring to FIG. 12B there is shown a more detailed flowchart of the process 255 for finding the most likely parent for each vertex. The process is initiated at block 272 where a selected vertex, V, is picked for an independent graph. A copy is then made of the list of vertices in graph G at block 274. The selected vertex, V, and the identified parents are removed from the copy of the list of vertices in block 276. At process block 280, the vertices whose introduction as a parent of V would create a cycle in the graph G are selected. The process then proceeds to block 282 where the determination is made of which new parent would most decrease the contribution made by V to the overall entropy. As previously mentioned, entropy is related to the mathematical formulation of the randomness in a data set. The new parent is then identified at block 284 and communicated to block 258 where an edge is added.

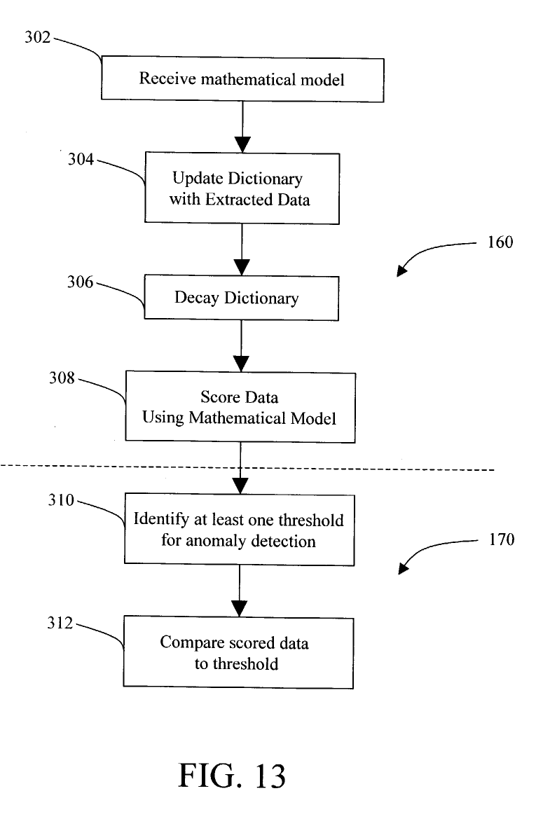

Referring to FIG. 13 there is shown a flowchart for scoring data using the mathematical model generated above. The process of scoring 160 begins at block 302 where the mathematical model is received. In the illustrative embodiment, the mathematical model is generated using the automated model generation methods described in FIG. 12A and FIG. 12B.

The process of scoring 160 then proceeds to update a dictionary with data in block 304. Typically, the data is extracted data generated on a real-time basis and gathered after performing the perspective analysis described above. For the illustrative embodiment, the term “dictionary” refers to a hash table. A hash table is a dictionary in which keys are mapped to array positions by a hash function. For the illustrative embodiment, the term “dictionary” also refers to the Python object of the same name. Python is an interpreted, interactive, object-oriented programming language that is used to generate the dictionary. Python is often compared to Tcl, Perl, Scheme or Java. However, for purposes of this disclosure the term “dictionary” is defined broadly and refers to the storage of data and/or extracted data.

In the illustrative embodiment, for any vertex V with a parent set P having one or more vertices, the data records associated with the V|P relationship are stored in a memory. By way of example, the storage of data records uses a collection of “dictionaries of dictionaries” has the form:

$$D ( V ) = \{ \begin{matrix}{p}_{1} \text{:} \{ None \text{:} {c}_{1} , {v}_{11} \text{:} ( {c}_{11} , {t}_{11} ) , {v}_{12} \text{:} ( {c}_{12} , {t}_{12} ) , … \} , \\ {p}_{2} \text{:} \{ None \text{:} {c}_{1} , {v}_{21} \text{:} ( {c}_{21} , {t}_{21} ) , {v}_{22} \text{:} ( {c}_{22} , {t}_{22} ) , … \} , \\ ⋮\end{matrix} \}$$

The “dictionaries of dictionaries” can also be represented by pi where the ith distinct value (essentially a tuple) is taken by the parents of V, so that the dictionary storage can be represented as:

D(V)[pᵢ]={None: cᵢ, vᵢ₁: (cᵢ₁,tᵢ₁), vᵢ₂: (cᵢ₂, tᵢ₂), . . . }

where:

cᵢ is the count of pᵢ

vᵢⱼ is the jth distinct value of the vertex for the ith distinct value of the parent.

cᵢⱼ is the count of vᵢⱼ

tᵢⱼ is a timestamp indicating when cᵢⱼ was last changed. The timestamp enables the determination of decay.

Thus, for the graph G shown below, the dictionary must be configured to store the data records associated with A, B|A, C|AB, and D|C which were determined by the parental decomposition process described in block 266 above.

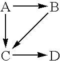

In operation, the bulk of the dictionary may be stored on a hard disk 20 and the most recent entries may be stored in RAM 18.

After updating the dictionary, the method proceeds to decay the dictionary in block 306. Typically, the dictionary is updated at approximately the same time as the dictionary is decayed. However, to avoid confusion as it relates to this description, the dictionary decay is described separately. The purpose for decaying the dictionary is to generate a dictionary that is influenced by historic data as well as the most recent data. Additionally, decaying the dictionary avoids generating large dictionaries that use all memory resources and processing resources. There are a variety of well known techniques that can be used to perform the dictionary decay. The preferred method of dictionary decay fixes an integer K. When a record with count c is accessed, the access time in the dictionary is updated and the count is changed according to the equation:

cr^{Δt}+K

where r<1, Δt is updated on a varying basis, and K is fixed globally. This decay formula permits the relative size of the counts to be efficiently influenced by historic data and by recent data.

At block 308, the process then proceeds to generate scored data using the updated and decayed dictionary and the mathematical model. During the scoring, each scored data record is assigned a real number value to indicate its relative surprise within the context of all data processed by the mathematical model received in block 302. Once the results from the scoring have been sorted, the scored data is communicated to the analyst for analysis 170. During the analysis 170, the analyst inspects scored data with the highest surprise value. At block 310, the scored data is analyzed by identifying at least one threshold. The scored data from block 308 is then compared to the threshold from block 310 to detect one or more anomalies.

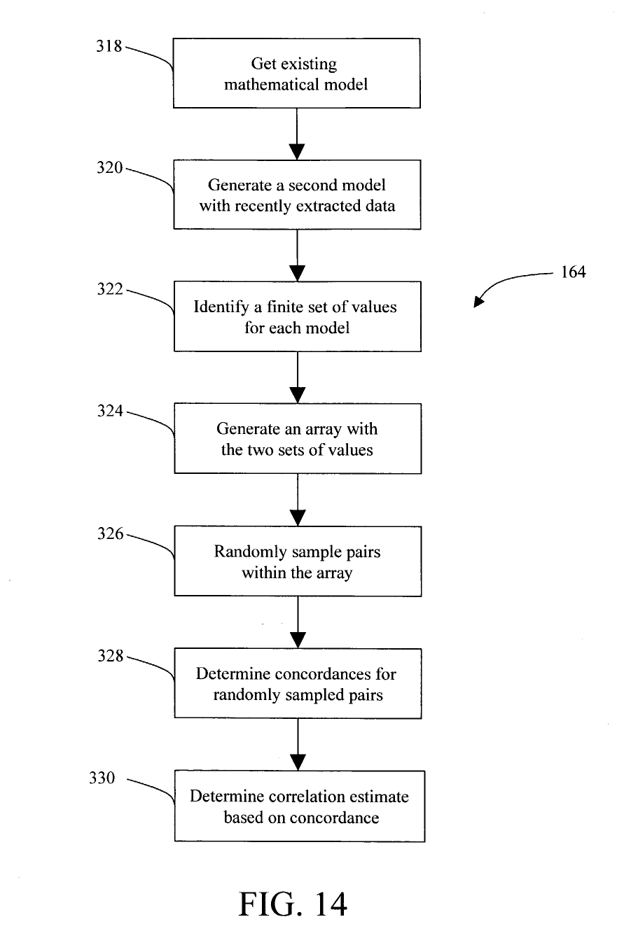

Referring to FIG. 14 there is shown a flowchart for a method for model validation. The method of model validation has been previously discussed in FIG. 3 and FIG. 4. The method of model validation is based on comparing mathematical models as described in process block 164 and in process 122 of FIG. 3 and FIG. 4, respectively. However, the process of model validation is not required to perform anomaly detection. Nevertheless, the process of model validation helps ensure that the model is strong and permits the model to be revised on a real-time basis.

The method of model validation is initiated at block 318 with a system getting the existing mathematical model. The existing mathematical model is also referred to as the first mathematical model. The desire to validate the existing mathematical model is due to changes in the network data records. Thus, the validation of the first mathematical models helps to ensure the model is current.

The first mathematical model is validated by comparing the first mathematical model to a second mathematical model. The second mathematical model is generated with recently extracted data as described by block 320. The first mathematical model includes more historical data than the second mathematical model.

The method then proceeds to block 322 where a finite set of values for each model is identified. For example, let X and Y be finite sets, each with N elements. As described in block 324, an array is generated with pairs having two sets of values. Thus, let P (for “pairs”) be a finite index set. The method then proceeds to process block 326 where pairs are randomly sampled within the array such that for each pε P, let iₚ and jₚ each be a random element of N. At block 328, the concordances for the randomly sampled pairs are then determined according to the concordance function:

c:(X×Y)×(Y×X)→{0,1}

given by:

$$c ( ( {x}_{1} , {y}_{1} ) , ( {x}_{2} , {y}_{2} ) ) = \{ \begin{matrix}1 & if sign ( {x}_{1} - {x}_{2} ) = sign ( {y}_{1} - {y}_{2} ) \\ 0 & otherwise\end{matrix}$$

The number of concordances, C, are then determined according to the following equation:

$$C = {\sum }_{p ∈ P} c ( ( {x}_{i ( p )} , {y}_{i ( p )} ) , ( {x}_{j ( p )} , {y}_{j ( p )} ) )$$

At block 330, the number of concordances, C, are then translated and scaled according to the following equation:

$$τ = \frac{2 C - P}{P}$$

This equation has the property of generating a correlation estimate, τ, that has the following range: −1≦τ≦1. Thus, the correlation between the first mathematical model and the second mathematical model is determined by a correlation estimate that is based on the concordances of randomly sampled pairs.

In operation, an allowable range may be set for τ, and the first mathematical model may be configured to perform a variety of actions if the allowable range of τ is exceeded. For example, the first mathematical model may be forced to regenerate if the allowable range of τ is exceeded. Additionally, all data used to generate the second mathematical model may be tracked. Furthermore, a decision may have to be made to replace the first mathematical model with another mathematical model. Further still, a more detailed analysis of the data used to perform the model validation may be conducted. Further yet, a signal may need to be sent to the security analyst that there is a change in network traffic.

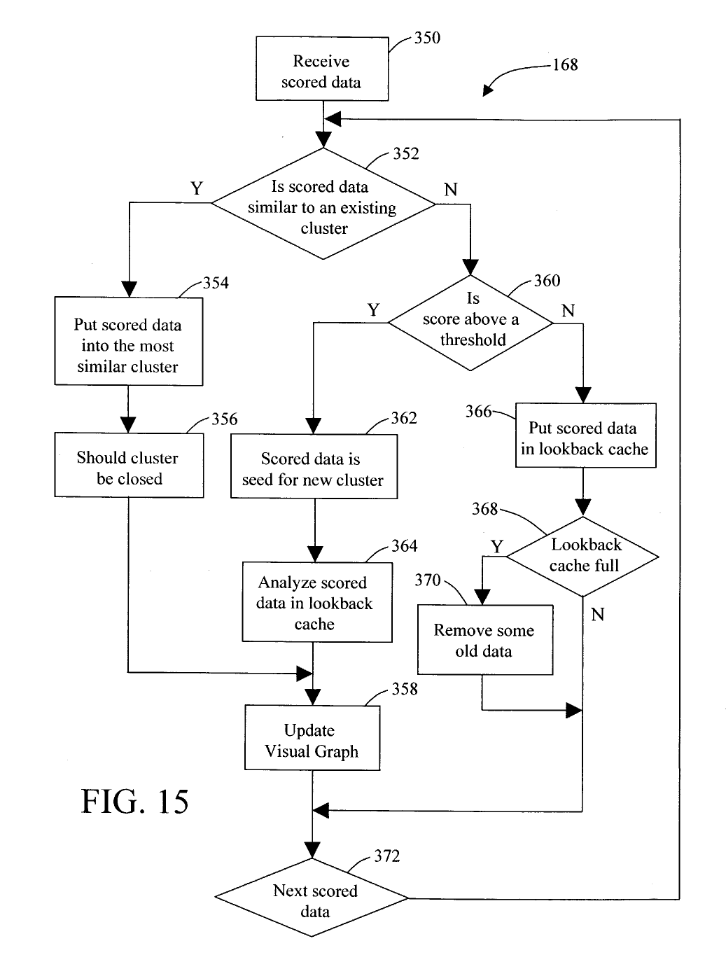

Referring to FIG. 15 there is shown a flowchart for a method of performing a clustering analysis. At block 350 the method provides for the receiving of scored data. At decision diamond 352, the determination is made if the scored data, x, is similar to scored data in an existing cluster, y. For the similarity measure, let

$$δ ( x , y ) = \{ \begin{matrix}1 & if x = y \\ 0 & if x \neq y\end{matrix}$$

Suppose there are N observations on K variables, and that the data matrix is: X=(xₙₖ|n=1, . . . , N; k=1, . . . , K), then the similarity measure is given by:

$$sim ( {x}_{i .} , {x}_{j .} ) = {\sum }_{k = 1}^{K} {w}_{k} δ ( {x}_{ik} , {y}_{jk} ) ,$$

where 0≦wₖ≦1 and Σwₖ=1.

If the determination is made at decision diamond 352 that the scored data is similar to an existing cluster, then the method proceeds to block 354 where the scored data is put into the most similar cluster. At block 356, the determination is made if the cluster should be closed. At block 358 the visual graph is updated with new cluster information generated from block 354 and block 356. The method proceeds to clustering the next scored data record.

If the determination is made at decision diamond 352 that the scored data is not similar to an existing cluster, the method proceeds to decision diamond 360. At decision diamond 360, the determination is made of whether the scored data is above a threshold. By way of example but not of limitation, the threshold is a default parameter that can be modified by the analyst.

If the scored data is above the threshold, the method proceeds to process block 362 where the scored data becomes a seed for a new cluster. At block 364, the lookback cache is analyzed to determine if any scored data residing in the lookback cache is similar enough to the recently scored data. If there is some scored data residing in the lookback cache that is similar enough to the recently scored date, then the recently scored data is clustered with the similar scored data residing in the lookback cache, and the visual graph at block 358 is updated. The method then proceeds to perform the clustering of the next scored data record.

If the scored data is below the threshold at decision diamond 360, the method proceeds to block 366 where the recently scored data is put into the lookback cache. At decision diamond 368, the determination is made whether the lookback cache is full. If the lookback cache is full, then some of the old data is removed as described by block 370. If the lookback cache is not full the method, then the clustering process bypasses the updating of the visual graph and proceeds to cluster the next scored data record as described by diamond 372.

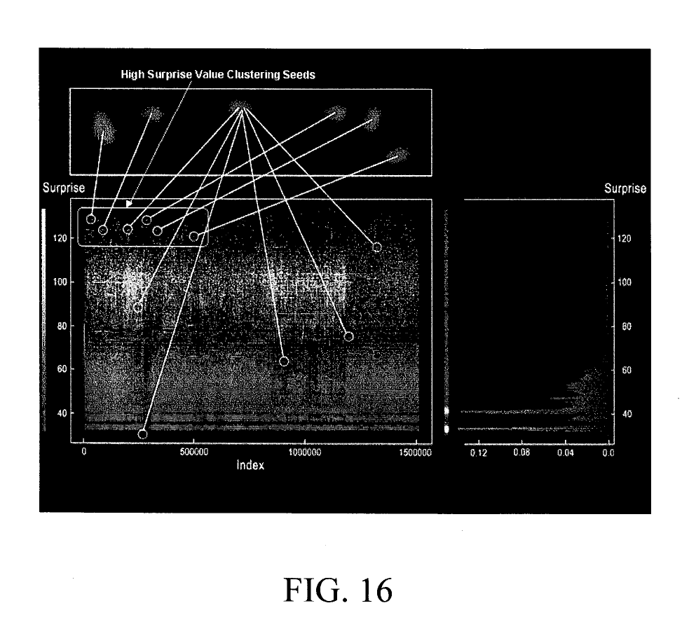

Referring to FIG. 16 there is shown an illustrative screenshot showing a visual graph generated with results associated with performing the scoring and clustering described above. The illustrative screenshot is generated with 1.5 million observations that are identified along the coordinate axis labeled “index” of the largest visual graph. The score or “surprise value” associated with each observation is identified along the coordinate axis labeled “surprise” on the largest visual graph. Observations having surprise values that exceed a certain threshold are identified and form the basis for generating the visual graph titled “High Surprise Value Clustering Seeds”. A histogram is also shown where the surprise values are the independent variable that are plotted on the vertical axis. The histogram is adjacent the visual graph labeled index and surprise.

By way of example and not of limitation, the illustrative screenshot may be used to detect various forms of network intrusion including scanning and probing activities, low and slow attacks, denial of service attacks, and other activities that threaten the network. For scanning and probing activities, a simple inspection of the scored results may be used. By way of example and not of limitation, scanning and probing activities may be detected when a single remote address is used to scan multiple hosts and ports on a local network. These activities tend to cluster around a small band of surprise values, if not the same surprise value.

Low and slow attacks occur so infrequently that detecting anomalous activities by using a single step approach is impractical. However, a practical two-step approach may be adopted for detecting the low and slow attacks. The first step of this two-step approach is to select all of the highest surprise records for each scored data record. The second step of this two-step approach is to store the highest surprise records in a separate low and slow attack database. Thus, the low and slow attack database could be relatively small and contain scored data over a long period of time that is on the order of months or years. When the low and slow database reaches a sufficient size, a new mathematical model can be derived from this database using the methods described above. The data associated with the new mathematical model is then analyzed by performing the processes described above that include model validation, scoring the extracted data and clustering the scored data.

A denial of service attack floods a server's resources and makes the server unusable. Denial of service attacks may be detected by simply measuring the difference between two mathematical models during the model validation process 122 and 164 described above. Additionally, denial of service attacks may be detected by monitoring changes of the weights that are assigned to each of the mathematical models.

The illustrative systems and methods described above have been developed to assist the cyber security analyst identify, review and assess anomalous network traffic behavior. These systems and methods address several analytical issues including managing large volumes of data by changing analytical perspectives, dynamically creating a mathematical model, adapting a mathematical model to a dynamic environment, measuring the differences between two mathematical models, and detecting basic shifts in data patterns. It shall be appreciated by those of ordinary skill in the various arts having the benefit of this disclosure that the system and methods described can be applied to many disciplines outside of the cyber security domain.

Furthermore, alternate embodiments of the invention which implement the systems in hardware, firmware, or a combination of goth hardware and software, as well as distributing the modlues and/or the data in a different fashion well be apparent to those skilled in the art and are also within the scope of the invention.

Although the description about contains many limitations in the specification, these should not be construed as limiting the scope of the claims but as merely providing illustrations of some of the presently preferred embodiments of this invention. Many other embodiments will be apparent to those of skill in the art upon reviewing the description. Thus, the scope of the invention should be determined by the appended claims, along with the full scope of equivalents to which such claims are entitled.

What is claimed is:

1. A method for detecting one or more anomalies in a plurality of observations, comprising:
selecting a perspective for analysis of said plurality of observations, said perspective configured to distinguish between a local data set and a remote data set;
applying said perspective to select a plurality of extracted data from said plurality of observations;
generating a first mathematical model with said plurality of extracted data;
generating a plurality of scored data by applying said extracted data to said first mathematical model; and
analyzing said plurality of scored data to detect said one or more anomalies.

2. The method of claim 1 wherein said plurality of observations are real-time observations.

3. The method of claim 2 wherein said plurality of observations include Internet Protocol (IP) addresses.

4. The method of claim 1 wherein said perspective is a geographic perspective in which one or more territorial boundaries are used to distinguish between said local data set and said remote data set.

5. The method of claim 1 wherein said perspective is an organizational perspective in which organizational boundaries are used to distinguish between said local data set and said remote data set.

6. The method of claim 1 wherein said perspective is a network perspective in which network boundaries are used to distinguish between said local data set and said remote data set.

7. The method of claim 1 in which said perspective is a host perspective wherein said local data set is associated with a particular host.

8. The method of claim 1 wherein said first mathematical model is a graphical mathematical model.

9. The method of claim 8 wherein said graphical mathematical model is a graphical Markov model.

10. The method of claim 1 wherein said first mathematical model is comprised of a plurality of vertices in which each vertex corresponds to a variable within said plurality of observations.

11. The method of claim 10 wherein said plurality of vertices are configured to represent a plurality of discrete variables.

12. The method of claim 11 wherein said plurality of vertices includes at least two vertices having an associated edge.

13. The method of claim 12 wherein said generating said first mathematical model with said plurality of extracted data further comprising generating said first mathematical with said plurality of observations being made on a real-time basis.

14. The method of claim 1 wherein said generating of said scored data further comprises generating a dictionary with said plurality of extracted data, said dictionary configured to store said plurality of extracted data.

15. The method of claim 14 wherein said dictionary is updated with extracted data collected on a real-time basis.

16. The method of claim 15 wherein said dictionary is decayed so that a plurality of older extracted data is discarded from said dictionary.

17. The method of claim 16 wherein said dictionary having been updated and decayed is used to generate said plurality of scored data with said first mathematical model.

18. The method of claim 1 wherein said analyzing said plurality of scored data further comprises identifying at least one threshold for anomaly detection.

19. The method of claim 18 wherein said analyzing said plurality of scored data further comprises comparing said plurality of scored data to said at least one threshold.

20. The method of claim 1 further comprising:
validating said first mathematical model by generating a second mathematical model using a plurality of recently extracted data; and
determining a correlation between said first mathematical model and said second mathematical model.

21. The method of claim 20 wherein said correlation is a correlation estimate based on concordances of randomly sampled pairs.

22. The method of claim 1 further comprising clustering said plurality of scored data.

23. The method of claim 22 wherein said clustering of said plurality of scored data is performed when said scored data is similar to an existing cluster.

24. The method of claim 23 wherein said clustering of said plurality of scored data further comprises providing a threshold for clustering said plurality of scored data.

25. The method of claim 1 further comprising:
validating said first mathematical model by generating a second mathematical model using a plurality of recently extracted data;
determining a correlation between said first mathematical model and said second mathematical model; and
clustering said plurality of scored data.

26. A system for detecting one or more anomalies in a plurality of observations, comprising:
a first memory configured to store said plurality of observations;
a input device configured to receive an instruction from an analyst, said instruction operative to select a perspective for analysis of said plurality of observations, said perspective configured to distinguish between a local data set and a remote data set; and
a processor programmed to:
apply said perspective to select a plurality of extracted data from said plurality of observations,
generate a first mathematical model with said plurality of extracted data,
generate a plurality of scored data by applying said extracted data to said first mathematical model, and
analyze said plurality of scored data to detection said one or more anomalies.

27. The system of claim 26 wherein said perspective is a geographic perspective in which one or more territorial boundaries are used to distinguish between said local data set and said remote data set.

28. The system of claim 26 wherein said perspective is an organizational perspective in which organizational boundaries are used to distinguish between said local data set and said remote data set.

29. The system of claim 26 wherein said perspective is a network perspective in which network boundaries are used to distinguish between said local data set and said remote data set.

30. The system of claim 26 in which said perspective is a host perspective wherein said local data set is associated with a particular host.

31. The system of claim 26 wherein said first mathematical model is a graphical mathematical model.

32. The system of claim 31 wherein said graphical mathematical model is a graphical Markov model.

33. The system of 26 wherein said processor programmed to generate said scored data is communicatively coupled to a second memory having a dictionary with said plurality of extracted data, said dictionary configured to store said plurality of extracted data.

34. The system of claim 33 wherein said dictionary is decayed so that a plurality of older extracted data is discarded from said dictionary.

35. The system of claim 34 wherein said dictionary having been updated and decayed is used to generate said plurality of scored data with said first mathematical model.

36. The system of claim 26 wherein said processor programmed to analyze said plurality of scored data is also programmed to select at least one threshold for anomaly detection.

37. The system of claim 26 wherein said processor is programmed to:
validate said first mathematical model by generating a second mathematical model with a plurality of recently extracted data, and
determine a correlation between said first mathematical model and said second mathematical model.

38. The system of claim 26 wherein said processor is programmed to cluster said plurality of scored data.

39. The system of claim 26 wherein said processor is programmed to:
validate said first mathematical model by generating a second mathematical model with a plurality of recently extracted data, and
determine a correlation between said first mathematical model and said second mathematical model; and
cluster said plurality of scored data.

40. A computer readable medium having computer-executable instructions for performing a method for detecting one or more anomalies in a plurality of observations, comprising:
selecting a perspective for analysis of said plurality of observations, said perspective configured to distinguish between a local data set and a remote data set;
applying said perspective to select a plurality of extracted data from said plurality of observations;
generating a first mathematical model with said plurality of extracted data;
generating a plurality of scored data by applying said extracted data to said first mathematical model; and
analyzing said plurality of scored data to detect said one or more anomalies.

41. The computer readable medium of claim 40 wherein said generating of said scored data further comprises generating a dictionary with said plurality of extracted data, said dictionary configured to store said plurality of extracted data collected on a real-time basis, said dictionary is decayed so that a plurality of older extracted data is discarded from said dictionary.

42. The computer readable medium of claim 40 wherein said analyzing said plurality of scored data further comprises identifying at least one threshold for anomaly detection and comparing said plurality of scored data to said at least one threshold.

43. The computer readable medium of claim 40 further comprising:
validating said first mathematical model by generating a second mathematical model using a plurality of recently extracted data; and
determining a correlation between said first mathematical model and said second mathematical model, said correlation is a correlation estimate based on concordances of randomly sampled pairs.

44. The computer readable medium of claim 40 further comprising clustering said plurality of scored data when said scored data is similar to an existing cluster and providing a threshold for clustering said plurality of scored data.

45. The computer readable medium of claim 40 further comprising:
validating said first mathematical model by generating a second mathematical model using a plurality of recently extracted data;
determining a correlation between said first mathematical model and said second mathematical model; and
clustering said plurality of scored data.

46. A computer security method for detecting one or more anomalies in a plurality of real-time network observations collected from a plurality of network traffic, comprising:
selecting a perspective for analysis of said plurality of network observations, said perspective distinguishes between a local data set and a remote data set;
applying said perspective to select a plurality of extracted data from said plurality of network observations;
generating a first mathematical model with said plurality of extracted data, said first mathematical model is a graphical mathematical model that includes a plurality of vertices in which each vertex corresponds to a variable within said plurality of network observations;
generating a plurality of scored data by applying said extracted data to said first mathematical model; and
analyzing said plurality of scored data to detect said one or more anomalies.

47. The method of claim 46 wherein said perspective is a geographic perspective in which one or more territorial boundaries are used to distinguish between said local data set and said remote data set.

48. The method of claim 46 wherein said perspective is an organizational perspective in which organizational boundaries are used to distinguish between said local data set and said remote data set.

49. The method of claim 46 wherein said perspective is a network perspective in which network boundaries are used to distinguish between said local data set and said remote data set.

50. The method of claim 46 in which said perspective is a host perspective wherein said local data set is associated with a particular host.

51. The method of claim 46 wherein said plurality of vertices is configured to represent a plurality of discrete variables.

52. The method of claim 46 wherein said generating of said scored data further comprises generating a dictionary with said plurality of extracted data, said dictionary configured to store said plurality of extracted data collected on a real-time basis, said dictionary is decayed so that a plurality of older extracted data is discarded from said dictionary.

53. The method of claim 46 wherein said analyzing said plurality of scored data further comprises identifying at least one threshold for anomaly detection and comparing said plurality of scored data to said at least one threshold.

54. The computer readable medium of claim 46 further comprising:
validating said first mathematical model by generating a second mathematical model using a plurality of recently extracted data; and
determining a correlation between said first mathematical model and said second mathematical model, said correlation is a correlation estimate based on concordances of randomly sampled pairs.

55. The computer readable medium of claim 46 further comprising clustering said plurality of scored data when said scored data is similar to an existing cluster and providing a threshold for clustering said plurality of scored data.

56. The computer readable medium of claim 46 further comprising:
validating said first mathematical model by generating a second mathematical model using a plurality of recently extracted data;
determining a correlation between said first mathematical model and said second mathematical model; and
clustering said plurality of scored data.

57. A method for extracting a plurality of data from a plurality of real-time network observations collected from a plurality of network traffic, comprising:
selecting a perspective for analysis of said plurality of network observations, said perspective configured to distinguish between a local data set and a remote data set; and
applying said perspective to select a plurality of extracted data from said plurality of network observations.

58. The method of claim 57 wherein said applying said perspective to select said plurality of extracted data further comprises,
identifying a source which generates a source local data set and a source remote data set, and
identifying a destination that receives a destination local data set and a destination remote data set.

59. The method of claim 58 wherein said applying said perspective to select said plurality of extracted data further comprises,
selecting a plurality of sent data which includes said source local data set that is sent to said destination remote data set, and
selecting a plurality of received data which includes said source remote data that is received by said destination local data set.

60. The method of claim 59 wherein said perspective is a geographic perspective in which one or more territorial boundaries are used to distinguish between said local data set and said remote data set.

61. The method of claim 59 wherein said perspective is an organizational perspective in which organizational boundaries are used to distinguish between said local data set and said remote data set.

62. The method of claim 59 wherein said perspective is a network perspective in which network boundaries are used to distinguish between said local data set and said remote data set.

63. The method of claim 59 in which said perspective is a host perspective wherein said local data set is associated with a particular host.

64. The method of claim 59 further comprising generating a dictionary with said plurality of extracted data, said dictionary configured to store said plurality of extracted data.

65. The method of claim 64 wherein said dictionary is updated with extracted data collected on a real-time basis.

66. The method of claim 65 wherein said dictionary is decayed so that a plurality of older extracted data is discarded from said dictionary.

67. A method for automatically generating a mathematical model that analyzes a plurality of real-time network observations collected from a plurality of network traffic, comprising:
generating a first mathematical model with a plurality of extracted data gathered from said plurality of real-time network observations, said first mathematical model is comprised of a plurality of vertices in which each vertex corresponds to a variable within said plurality of network observations;
updating a dictionary with said plurality of extracted data;
decaying said dictionary so that a plurality of older extracted data is discarded from said dictionary; and
generating a plurality of scored data by applying said plurality of extracted data from said dictionary to said first mathematical model.

68. The method of claim 67 further comprising analyzing said plurality of scored data by identifying at least one threshold for anomaly detection.

69. The method of claim 67 further comprising:
validating said first mathematical model by generating a second mathematical model using a plurality of recently extracted data; and
determining a correlation between said first mathematical model and said second mathematical model.

70. The method of claim 69 wherein said correlation is a correlation estimate based on concordances of randomly sampled pairs.

71. The method of claim 67 further comprising clustering said plurality of scored data.

72. The method of claim 71 wherein said clustering of said plurality of scored data is performed when said scored data is similar to an existing cluster.

73. The method of claim 67 further comprising:
validating said first mathematical model by generating a second mathematical model using a plurality of recently extracted data;
determining a correlation between said first mathematical model and said second mathematical model; and
clustering said plurality of scored data.
